(19) United States
(12) Patent Application Publication
(10) Pub. No.: US 2022/0286952 A1
(43) Pub. Date: Sep. 8, 2022

(54) OPTIMIZATION ENGINE, OPTIMIZATION METHOD, AND PROGRAM

(71) Applicant: NIPPON TELEGRAPH AND TELEPHONE CORPORATION, Tokyo (JP)

(72) Inventors: Hiroya ONO, Musashino-shi, Tokyo (JP); Satoshi NARIKAWA, Musashino-shi, Tokyo (JP)

(73) Assignee: NIPPON TELEGRAPH AND TELEPHONE CORPORATION, Tokyo (JP)

(21) Appl. No.: 17/632,055

(22) PCT Filed: Jan. 22, 2020
(86) PCT No.: PCT/JP2020/002153

§ 371 Date: Feb. 1, 2022

(30) Foreign Application Priority Data
Aug. 6, 2019 (JP) PCT/JP2019/030896

(51) Int. Cl. H04W 48/18; H04W 40/12; H04W 28/02; H04W 28/08

(52) U.S. Cl. CPC H04W 48/18; H04W 40/12; H04W 28/0236; H04W 28/0815

(57) ABSTRACT

An object of the present invention is to provide an optimization engine, an optimization method, and a program that are excellent in extendibility, make it easy to effectively use unique features of respective access networks, and can improve the degree of satisfaction of various users. An optimization engine according to the present invention includes an objective function of an item to be improved, collects parameters from access networks and terminals, and finds a combination of connection destinations that maximize or minimize the objective function. By appropriately setting the objective function, it is possible to control the degree of user satisfaction, bandwidth usage ratio, line usage cost, or the like.

### TECHNICAL FIELD

The present disclosure relates to an optimization engine, an optimization method, and a program for selecting an optimum access network from a plurality of access networks.

### BACKGROUND ART

When a user uses a network service, a communication line that is provided by a communication carrier may be used. Various physical mediums such as optical lines and wireless communication lines can be used. For example, in the case of optical lines, there are communication standards such as IEEE 802.3 (Ethernet (registered trademark)) and ITU-T G.983/G.984/G.987/G.989. Also, in the case of wireless communication lines, there are communication standards such as 3GPP 36Series (LTE), IEEE802.11 (wireless LAN), and IEEE 802.16 (WiMAX).

A user terminal can perform communication by selectively using a plurality of communication standards. For example, in the case of a smartphone, a user can select which of LTE, wireless LAN, and Bluetooth (registered trademark) is to be used. It is also possible to selectively use lines of different carriers that use the same communication standards.

Access networks differ from each other in communication quality such as the frequency band and delay, and therefore, the access networks need to be appropriately selected depending on use. As shown in FIG. 1, a user can manually switch an access network to be used by changing settings of the user terminal. However, in a case where many networks can be used, there is a difficulty in that the user needs to understand features of respective access networks and appropriately select an access network manually.

If the user terminal is connected to an access network that does not have communication quality desired by the user or that does not fit the purpose of the user, communication quality also decreases for other user terminals using the access network. As described above, there is a risk of communication resources of the entire network system being not effectively used.

When the user terminal is connected to an access network that does not have communication quality desired by the user, the following situation occurs, for example.

When the user uses an access network such as a public wireless LAN in a station or the like for which radio wave intensity is not sufficiently high, the level of modulation is lowered, and accordingly, a large portion of communication resources such as time and frequency needs to be allocated to the user. That is, communication quality of other users largely decreases due to allocation of the communication resources.

Also, when the user terminal is connected to an access network that does not fit the purpose of the user, the following situation occurs.

Assume that there is a network (a) that has a small total bandwidth but in which delay is low. If a large portion of the frequency band of the network (a) is used by a user who uses an application such as video viewing that does not require low-delay communication, communication delay increases for another user who uses an application such as an online game that requires low-delay communication, and the degree of satisfaction of the other user largely decreases. That is, the degree of satisfaction of another user may decrease as a result of the user terminal being connected to an access network that does not fit the purpose of the user.

With regard to the above difficulty, it is known to provide a user terminal with a function of automatically selecting an access network (see PTL 1, for example). This function is a function of estimating communication quality from radio wave intensity or the like of a wireless LAN line that can be used, and preferentially connecting to the wireless LAN line if sufficient quality can be expected and the wireless LAN line can be used.

This function estimates the communication quality from information regarding wireless access. Accordingly, the estimated value may differ from actual communication quality due to the degree of congestion of an upper network or behavior of other user terminals. There is a problem in that in order to acquire the actual communication quality, it is necessary to once connect to the line and measure the quality.

There is also a problem in that this function cannot control connection destinations of other user terminals, and therefore, it is difficult to optimize networks in the entire system. For example, assume a case where a user 1 wants to use an application that requires low-delay communication, but a network 2 in which the low-delay communication can be performed has already been occupied by a terminal of a user 2 who is using an application for which requirements regarding delay are not strict. In this case, delay occurs in communication performed by the user 1, and it is difficult to satisfy the user 1. On the other hand, communication quality is excessively high for the user 2. As described above, it is difficult to optimize a service with the function described in PTL 1.

On the other hand, in order to solve the problem of PTL 1 (optimize the entire network system), there is a method in which a server or a base station device in a network designates a connection destination for a user terminal (see NPL 1, for example). FIG. 3 is a diagram showing the method of NPL 1. With this method, it is possible to collectively control connection destinations of a plurality of users giving consideration to the degree of congestion of the entire network, and therefore, optimization can be accurately performed for all users. According to NPL 1, it is possible to improve the throughput of the entire system in an environment in which a 3GPP line and a wireless LAN line coexist.

### CITATION LIST

### Patent Literature

[PTL 1] JP 2012-169971A

### Non Patent Literature

[NPL 1] D. Kimura, “A Novel RAT Virtualization System with Network-Initiated RAT Selection Between LTE and WLAN”, 978-1-5090-4183-1/17,2017 IEEE
[NPL 2] https://business.ntt-east.co.jp/service/azukerunms/, searched on Dec. 31, 2019
[NPL 3]https://www.ntt.com/business/services/application/mail-groupwa re/office365.html, searched on Dec. 31, 2019

### SUMMARY OF THE INVENTION

### Technical Problem

A selection algorithm for selecting connection destinations autonomously by the network described in NPL 1 is an algorithm for a choice between two alternatives such as switching between LTE and a wireless LAN. That is, there is a problem in that it is difficult to extend NPL 1 to an environment in which a larger number of types of access networks can be used.

In the selection algorithm described in NPL 1, an objective function used for the optimization is a variable of the throughput only, and there is also a problem in that it is difficult to improve the degree of user satisfaction with respect to an application for which an index other than the throughput is important. In recent years, there are applications for which the degree of satisfaction is largely affected by delay and delay variation, and the degree of user satisfaction cannot be sufficiently improved with a method of selecting connection destinations taking only the throughput into consideration.

Furthermore, each communication standard has physical properties that are determined by radio frequencies and the like, and unique feature values such as the cost that are determined by the form of a service. In the selection algorithm described in NPL 1, these feature values are not taken into consideration, and connection destinations are selected without features of respective access networks being reflected. That is, according to NPL 1, it is not possible to select connection destinations taking features of respective access networks into consideration, and there is a first problem in that the degree of user satisfaction cannot be sufficiently improved in this respect as well.

Therefore, in order to solve the above problem, a first object of the present invention is to provide an optimization engine, an optimization method, and a program that are excellent in extendibility, make it easy to effectively use unique features of respective access networks, and can improve the degree of satisfaction of various users.

On the other hand, Internet communication has been the mainstream of conventional data communication, but in recent years, cloud services become popular and there are demands for low-delay applications. To meet such a demand, there is a case where an application server is installed in a network of a telecommunications carrier, and is provided as a service together with a communication line (see NPL 2 and NPL 3, for example). In such a case, it is necessary to limit the connection destination to the network to use the application or the service, or it is necessary to connect to the specific network to improve experience quality of the application.

However, PTL 1 discloses a method for optimizing a communication path from the upper network to the Internet, and does not consider:

(1) an application that can be used only under a specific network; and
(2) an application of which experience quality increases under a specific network
as described above. Therefore, PTL 1 has a second problem in that a user who wants to use such an application is not always connected to a desired access path.

Therefore, in order to solve the above problem, a second object of the present invention is to provide an optimization engine, an optimization method, and a program that can improve accuracy in selecting a network that is suitable for an application, and improve experience quality.

### Means for Solving the Problem

In order to achieve the objects described above, an optimization engine according to the present invention includes an objective function of an item that is to be improved, collects parameters from access networks and terminals, and finds a combination of connection destinations that maximize or minimize the objective function.

More specifically, an optimization engine according to the present invention is an optimization engine for optimizing a communication system, wherein

the communication system has a configuration in which a plurality of terminals are each connected to an upper network via any of a plurality of access networks,

the optimization engine including:

an information collecting unit configured to collect communication quality information and network feature values for each of the access networks and availability information for each of the terminals, the availability information indicating which of the access networks can be used by the terminal;

a candidate selection unit configured to create connection destination candidates for each of the terminals based on the availability information, the connection destination candidates being candidates for an access network among the access networks to which the terminal is to be connected;

a quality estimation unit configured to estimate communication quality with respect to the connection destination candidates based on the communication quality information, to obtain estimated communication quality; and

a determination unit configured to determine an optimum connection destination from among the connection destination candidates based on a calculation value that is obtained by substituting the network feature values and the estimated communication quality into an objective function that is set in advance.

Also, an optimization method according to the present invention is an optimization method for optimizing a communication system, wherein

the communication system has a configuration in which a plurality of terminals are each connected to an upper network via any of a plurality of access networks,

the optimization method including:

collecting communication quality information and network feature values for each of the access networks and availability information for each of the terminals, the availability information indicating which of the access networks can be used by the terminal;

creating connection destination candidates for each of the terminals based on the availability information, the connection destination candidates being candidates for an access network among the access networks to which the terminal is to be connected;

estimating communication quality with respect to the connection destination candidates based on the communication quality information, to obtain estimated communication quality; and

determining an optimum connection destination from among the connection destination candidates based on a calculation value that is obtained by substituting the network feature values and the estimated communication quality into an objective function that is set in advance.

The optimization engine and the optimization method select a combination of connection destinations from the plurality of access networks based on the objective function that takes a plurality of communication quality parameters and a plurality of network feature values as variables. By appropriately setting the objective function, it is possible to control the bandwidth usage ratio, line usage cost, or the like. A connection destination of a user terminal can be determined based on a suitable objective function using values that can be acquired from network devices and user terminals or values that can be determined using those values.

For example, it is possible to determine a connection destination candidate that maximizes or minimizes the objective function, as the optimum connection destination.

Therefore, the present invention can provide an optimization engine and an optimization method that are excellent in extendibility, make it easy to effectively use unique features of respective access networks, and improve the degree of satisfaction of various users, and can achieve the first object.

Here, it is preferable that the network feature values include correspondence information that indicates correspondence between an application and a specific access network among the access networks in which the application can be realized, the information collecting unit also collects application information of the application that the terminal uses, together with the availability information, and a utility function for reflecting the correspondence information and the application information in the calculation value is set in the determination unit.

Also, it is preferable that the optimization method further includes: collecting application information of the application that the terminal uses, together with the availability information; and reflecting the correspondence information and the application information in the calculation value by using a utility function.

By setting the objective function such that the value of the objective function increases or decreases if the specific access network is used according to the application, it is possible to increase the probability of the terminal being connected to the specific access network, based on information of the application that is to be used by the terminal.

Therefore, the present invention can provide an optimization engine, an optimization method, and a program that can improve accuracy in selecting a network that is suitable for an application, and improve experience quality, and can achieve the second object.

The optimization engine according to the present invention further includes a notification unit configured to output connection instructions to the terminals and/or the access networks such that each of the terminals is connected to an access network that is the optimum connection destination.

Also, the optimization method according to the present invention further includes outputting connection instructions to the terminals and/or the access networks such that each of the terminals is connected to an access network that is the optimum connection destination.

A program according to the present invention is a program for causing a computer to function as the optimization engine. The optimization engine according to the present invention can be realized by a computer and a program, and the program can be recorded on a recording medium or provided via a network.

### Effects of the Invention

The present invention can provide an optimization engine, an optimization method, and a program that are excellent in extendibility, make it easy to effectively use unique features of respective access networks, and can improve the degree of satisfaction of various users.

Also, the present invention can provide an optimization engine, an optimization method, and a program that can improve accuracy in selecting a network that is suitable for an application, and improve experience quality.

### BRIEF DESCRIPTION OF DRAWINGS

FIG. 1 is a diagram showing a communication system relating to the present invention.

FIG. 2 is a diagram showing a communication system relating to the present invention.

FIG. 3 is a diagram showing a communication system relating to the present invention.

FIG. 4 is a diagram showing a communication system that includes an optimization engine according to the present invention.

FIG. 5 is a diagram showing a communication system that includes the optimization engine according to the present invention.

FIG. 6 is a diagram showing a communication system that includes the optimization engine according to the present invention.

FIG. 7 is a diagram showing operations of the optimization engine according to the present invention.

FIG. 8 is a diagram showing operations of a communication system that includes the optimization engine according to the present invention.

FIG. 9 is a diagram showing a communication system that includes the optimization engine according to the present invention.

FIG. 10 is a diagram showing the optimization engine according to the present invention.

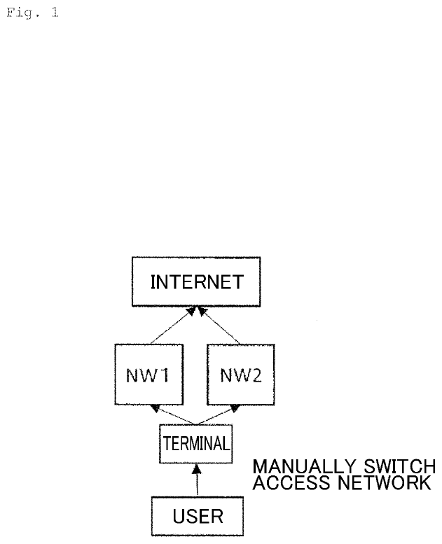

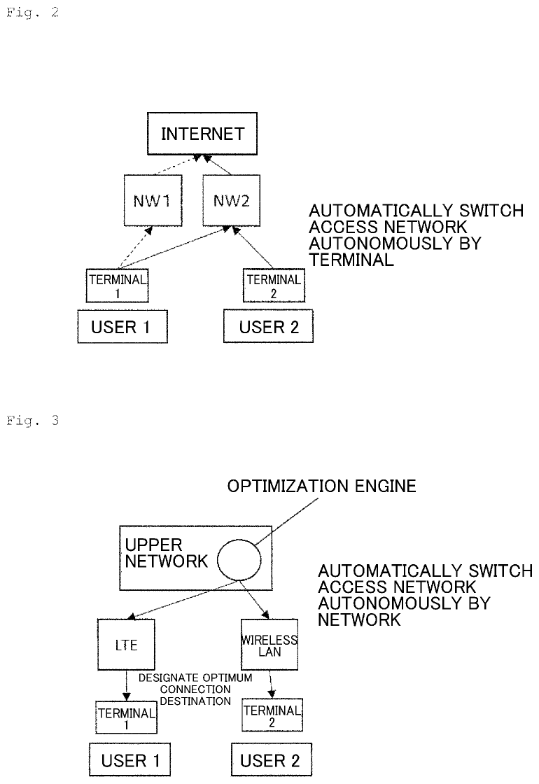

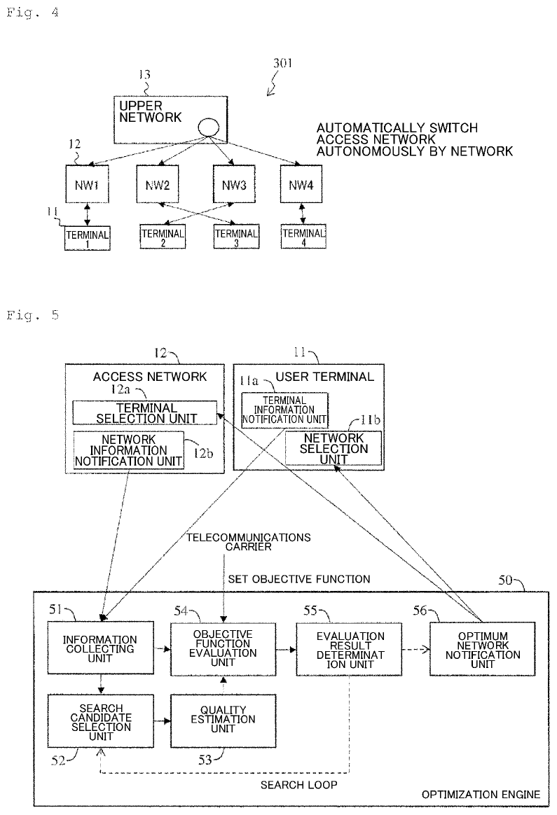

### DESCRIPTION OF EMBODIMENTS

Embodiments of the present invention will be described with reference to the accompanying drawings. The embodiments described below are examples of the present invention, and the present invention is not limited to the following embodiments. Note that constitutional elements that are denoted with the same reference signs in the present specification and the drawings are identical to each other.

### Embodiment 1

Communication System

FIG. 4 is a diagram showing a communication system 301 that includes an optimization engine 50 according to the present embodiment. The communication system 301 has a configuration in which a plurality of terminals 11 are each connected to an upper network 13 via any of a plurality of access networks (NWs) 12. The communication system 301 shown in FIG. 4 includes four terminals 11 and four NWs 12, but the number of terminals and the number of NWs are not limited to four.

The optimization engine 50 dynamically selects a combination of connections between the terminals 11 and the NWs 12 from the plurality of NWs 12 by calculating an objective function such as a user satisfaction function that takes a plurality of communication quality parameters and a plurality of network feature values as variables. Note that “dynamically select” means periodically calculating the objective function and switching the combination of connections according to the calculation result. The communication quality parameters are parameters relating to the total bandwidth, delay, delay variation, the number of TCP sessions that can be used, the number of IP addresses that can be used, or other communication quality of each NW.

The network feature values are values that represent a line usage cost, tolerance to movement of a user (mobility), the presence or absence of encryption, or other features of each network.

So long as the communication quality parameters and the network feature values are values that can be acquired from network devices and user terminals or can be determined using those values, NWs 12 to which the terminals 11 are to be connected are determined based on a suitable objective function.

The following effects can be achieved with the optimization engine 50.

(1) An appropriate NW 12 to be used by a terminal 11 can be selected in an environment in which there are many NWs 12.
(2) A connection destination selection algorithm can be easily extended even when the number of available NWs 12 increased.
(3) Each terminal 11 can select a NW 12 that increases the degree of satisfaction even for an application of which the degree of satisfaction is affected by a plurality of parameters other than throughput.
(4) Terminals 11 and NWs 12 can be connected with consideration given to features of the respective NWs 12.
(5) By designing the objective function, it is possible to realize connections between the terminals 11 and the NWs 12 so as to meet various demands such as maximizing the degree of user satisfaction or averaging load ratios of respective networks. That is, by setting a desired objective function in the optimization engine 50, it is possible to control the entire communication system 301, taking bandwidth usage ratios, line usage costs, or the like of the NWs 12 into consideration.

### SUPPLEMENTARY NOTE

The “connection destination selection algorithm” refers to a series of steps for selecting connection destinations that are NWs to be selected by user terminals (repeatedly performing steps (search loop) of selecting search candidates, estimating quality, and evaluating the objective function after a step of setting the objective function, which will be described later).

“The connection destination selection algorithm can be easily extended” means that it is possible to deal with a change in types and the number of available NWs and a change in the number of terminals by mainly extending functions of a quality estimation unit, without the need for changing the above-described series of steps and the objective function. The reason why “the connection destination selection algorithm can be easily extended” is that functional units for setting the objective function, selecting search candidates, estimating quality, and evaluating the objective function, which will be described later, are highly independent, and the functions can be easily extended. That is, when the number of available NWs has increased, it is possible to deal with the change by merely changing some of the functions, and the objective function and a flowchart need not be largely changed.

Note that many of conventional algorithms for selecting connection destinations are methods for a choice between two alternatives, i.e., a 3GPP line and a wireless LAN line, as is the case with NPL 1, and the algorithms need to be largely changed to be applied to three or more NWs. Furthermore, in such methods, features and relationships of the 3GPP line and the wireless LAN line are often directly reflected in a function for selecting connection destinations (i.e., the function is designed exclusively for a choice between the 3GPP line and the wireless LAN line), and the function for selecting connection destinations needs to be rebuilt to introduce a new NW.

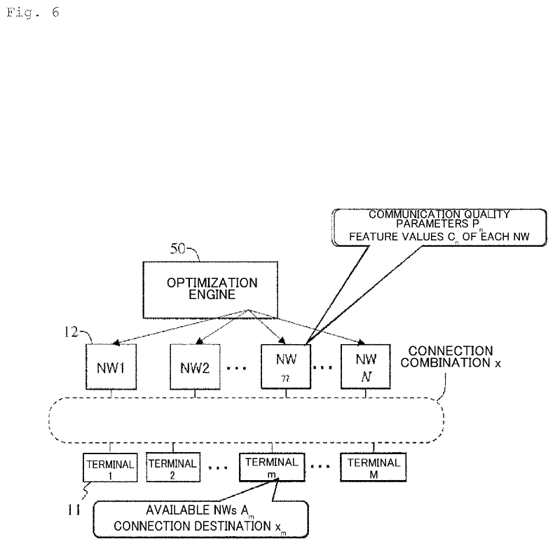

FIG. 5 is a block diagram showing functions of a terminal 11, an access network 12, and the optimization engine 50.

The terminal 11 includes a terminal information notification unit 11a that notifies the optimization engine 50 of an application that the terminal 11 uses and NWs 12 that can be used by the terminal 11.

The terminal 11 includes a network selection unit 11b that accepts an instruction from the optimization engine 50 and switches a NW 12 that the terminal 11 uses.

The NW 12 includes a terminal selection unit 12a that accepts an instruction from the optimization engine 50 and switches a terminal 11 to which the NW 12 connects. Note that a configuration is also possible in which either one of the terminal selection unit 12a of the NW 12 and the network selection unit 11b of the terminal 11 is used, but both of these units may also be used at the same time.

The NW 12 includes a network information notification unit 12b that notifies the optimization engine 50 of communication quality information regarding the NW 12 such as a frequency band that can be used by the NW 12.

The optimization engine 50 includes an information collecting unit 51 that collects information from the information notification unit 11a of the terminal 11 and the network information notification unit 12b of the NW 12.

The optimization engine 50 includes a search candidate selection unit 52 that defines a set of connection combinations of the terminals 11 and the NWs 12, and extracts a connection combination candidate in a search from the set.

The optimization engine 50 includes a quality estimation unit 53 that simulates or estimates quality by simulating the real world. The quality estimation unit 53 takes the connection combination candidate as an input and outputs estimated quality for each terminal 11 when the terminals are connected in accordance with the combination.

The optimization engine 50 includes an objective function evaluation unit 54 that calculates the value of an objective function based on communication quality of each terminal 11 and the like.

The optimization engine 50 includes an evaluation result determination unit 55 that determines whether to perform a search for a connection combination again or end the search, based on the result of calculation performed by the objective function evaluation unit 54.

The optimization engine 50 includes an optimum network notification unit 56 that notifies each terminal 11 and/or each NW 12 of a finally determined connection combination.

In the optimization engine 50,

the information collecting unit 51 collects communication quality information (“P”, which will be described later) and network feature values (“C”, which will be described later) for each NW 12, and availability information (“A”, which will be described later) indicating which of the NWs 12 can be used, for each terminal 11,

the search candidate selection unit 52 creates, for each terminal 11, connection destination candidates (connection combinations) that are candidates for a NW 12 to which the terminal 11 is to be connected, based on the availability information,

the quality estimation unit 53 estimates communication quality (outputs estimated communication quality) with respect to the connection destination candidates based on the communication quality information,

the objective function evaluation unit 54 substitutes the network feature values and the estimated communication quality into an objective function that is set in advance, and

the evaluation result determination unit 55 determines a connection destination candidate that maximizes or minimizes the objective function, as the optimum connection destination.

Then, the optimum network notification unit 56 outputs connection instructions to the terminals 11 and/or the NWs 12 such that each terminal 11 is connected to a NW 12 that is the optimum connection destination.

Operations

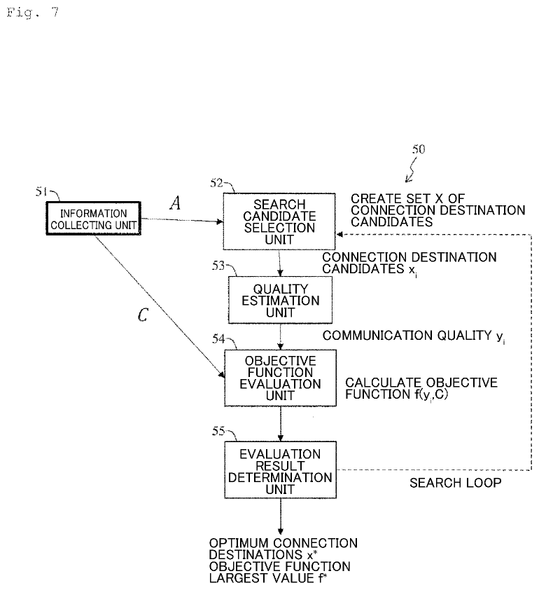

FIG. 6 is a diagram showing operations of the optimization engine 50. Assume that each terminal 11 can use up to N types of NWs 12 in the communication system. An array of values of communication quality parameters such as the total bandwidth and an average delay of the n-th NW 12 is represented by a vector Pₙ. Also, an array of feature values other than communication quality of the n-th NW 12 is represented by a vector Cₙ. The number of elements of the vector Pₙ and the number of elements of the vector Cₙ are respectively equal to the number of communication quality parameters and the number of feature values that are taken into consideration. Also, a set of vectors Pₙ is represented by P, and a set of vectors Cₙ is represented by C.

[Math. 1]

P={Pₙ|1≤n≤N}

C={Cₙ|1≤n≤N} (1)

Note that the vector C, may also include a list of applications that are realized in the n-th NW 12.

There are M terminals 11 in the communication system. An array indicating NWs 12 that can be used by the m-th terminal 11 is represented by a vector Aₘ, and a set of vectors Aₘ is represented by A. Numbers of the NWs 12 that can be used are written in the vector Aₘ, and the vector A includes the same number of elements as the NWs 12 that can be used. Alternatively, the vector Aₘ may be defined as an array that includes N elements and in which the i-th element A_{m,i} as shown in the following expression.

$$\begin{matrix}[ Math . 2 ] & \\ {A}_{m , i} = \{ \begin{matrix}0 & \begin{matrix}if the i - th access network cannot \\ be used\end{matrix} \\ 1 & if the i - th access network can be used\end{matrix} & ( 2 )\end{matrix}$$

$$\begin{matrix}[ Math . 3 ] & \\ A = \{ {A}_{m} \vert 1 \leq m \leq M \} & ( 3 )\end{matrix}$$

Note that the vector Aₘ may also include information (application information) of an application that the m-th terminal 11 uses.

FIG. 7 is a diagram showing operations of the optimization engine 50.

A combination of NWs 12 to which the M terminals 11 are respectively connected is represented by a vector x, and the m-th element xₘ of the vector x indicates the number of a NW 12 to which the m-th terminal 11 is connected (1≤xₘ≤N).

The search candidate selection unit 52 of the optimization engine 50 creates a set X of connection destination candidates of respective terminals, taking as an input an available access network A that is a set of vectors Aₘ representing NWs 12 that can be used by the respective terminals 11.

Note that the vector x is a vector in which the NW number xₘ of the connection destination to which the m-th terminal is connected is arranged with respect to all terminals. The vector x may be referred to as a “connection combination”. On the other hand, the vector Aₘ is a vector in which NW numbers of NWs that can be used by the m-th terminal (i.e., that can be connection destination candidates) are arranged.

Then, the search candidate selection unit 52 creates a set X that includes connection destination candidates of all terminals, using the set A of vectors Aₘ of all the terminals. Furthermore, in a first (i=1) search loop, the search candidate selection unit 52 selects a connection destination candidate for each terminal from the set X, arrange the selected connection destination candidates of respective terminals, and inputs the connection destination candidates as a vector xᵢ of the connection destination candidates to the quality estimation unit 53. Every time the search loop is performed, the search candidate selection unit 52 changes the connection destination candidate of at least one terminal to create a new vector xᵢ of connection destination candidates. That is, the connection combination x changes every time the search loop is performed.

The quality estimation unit 53 receives the connection destination candidates xᵢ from the search candidate selection unit 52 and calculates communication quality y; of all the terminals. The communication quality yᵢ is a vector and is a function (yᵢ(xᵢ)) of the connection destination candidates xᵢ. The m-th element y_{i,m} of the communication quality yᵢ is communication quality that is achieved by the m-th terminal in the connection combination of the i-th search loop.

An objective function that is set in the objective function evaluation unit 54 is represented by f(yᵢ(xᵢ),C). The largest value or the smallest value of the objective function obtained before the i-th search loop is represented by f*. Also, connection destination candidates with which f* is obtained are represented by x*. The objective function evaluation unit 54 outputs the connection destination candidates x* by calculating the following expression using the set C of feature values obtained from the information collecting unit 51, the communication quality yᵢ (xᵢ), and the objective function.

$$\begin{matrix}[ Math . 4 ] & \\ {x}^{*} = {argmax}_{1 \leq k \leq i} f ( {y}_{k} ( {x}_{k} ) , C ) or {x}^{*} = {argmin}_{1 \leq k \leq i} f ( {y}_{k} ( {x}_{k} ) , C ) & ( 4 )\end{matrix}$$

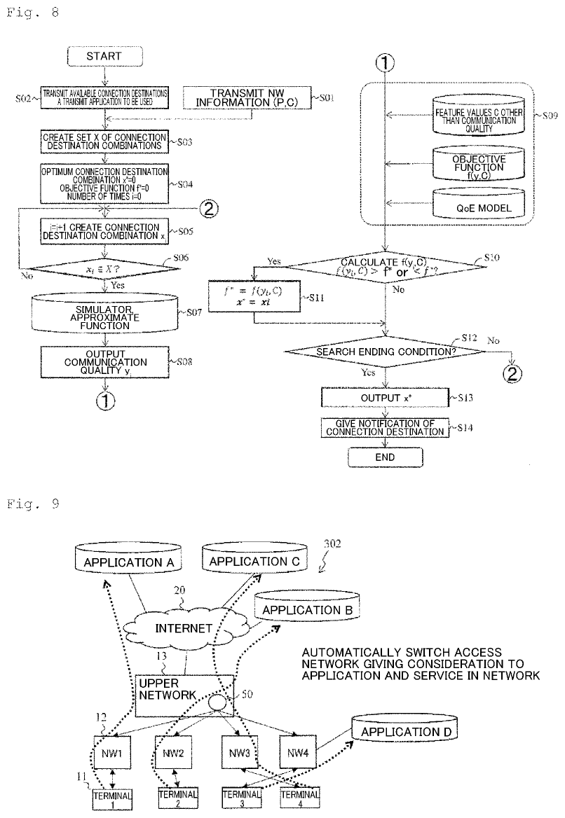

FIG. 8 is a flowchart showing operations of the communication system 301.

The network information notification unit 12b of each NW 12 notifies the information collecting unit 51 of the optimization engine 50 of communication quality information (vector Pₙ) and feature values (vector CA) other than communication quality. Note that if there are applications that are realized in the NW 12, a list of the applications may also be included in the notification. The information collecting unit 51 creates a set P and a set C from the communication quality information and the feature values of the notification.

The information notification unit 11a of each terminal 11 notifies the information collecting unit 51 of the optimization engine 50 of access networks that can be used at a given point in time and an application that is being used or is to be used by the terminal 11 (vector Aₙ) (step S02). The information collecting unit 51 creates available applications (set A) from the applications of the notification.

The notification of information in step S01 and step S02 may be performed in any order, and may also be performed at the same time. There is no limitation to the order of terminals and the order of networks. Also, in a case where states of the terminals and the networks are already known and a dynamic change does not occur, a configuration is also possible in which these steps are not performed and the information is set in advance.

The search candidate selection unit 52 of the optimization engine 50 creates a set X of connection destination combinations of the terminals using the set A (step S03).

The search candidate selection unit 52 initializes the number i of times of solution search loop, the largest value or the smallest value f* of the objective function, and connection destinations x* with which f* is obtained (initial values are 0 or a zero vector).

Step S03 and step S04 may be performed in any order, and may also be performed at the same time.

The search candidate selection unit 52 of the optimization engine 50 extracts an element xᵢ from the set X of connection destination candidates. The quality estimation unit 53 estimates communication quality yᵢ that is realized when the element x; is input, by using the set P (steps S05 to S08). The element xᵢ may be extracted at random from X or all elements may be extracted in a specific order. It is also possible to use a method of randomly creating the element xᵢ, and estimating quality only when it is confirmed that xᵢ∈X (step S06).

The communication quality yᵢ may be estimated using any method (step S07). For example, it is possible to use a method of outputting a result of simulation that is performed using a system in which a distribution of real networks and users is simulated. It is possible to estimate communication delay or the like in addition to the throughput by using “ns-3”, “QualNet”, “OpNet Modeler”, or another network simulator. In a case where it is desired to estimate only the throughput, the throughput can be estimated simply by dividing the total bandwidth of each network by the number of users connected to the network, for example.

The objective function evaluation unit 54 uses an objective function f(yᵢ,C) that is given in advance, and calculates the value of the objective function from communication quality yᵢ obtained with respect to the connection destination candidate element xᵢ and the feature values C other than communication quality (step S10). For example, in a case where the objective function f(yᵢ,C) includes QoE (Quality of experience) that represents the degree of user satisfaction, the value of QoE is determined from the communication quality yᵢ and the feature values C using a QoE model (step S09) that is determined by applications used by respective terminals, which are obtained in step S02. More specifically, when it is assumed that web browsing is being executed as an application, QoE can be estimated from the communication quality yᵢ by using a QoE model for web browsing, a bandwidth required for the web page, and an average throughput.

If the value of the objective function f(yᵢ,C) obtained in the i-th search loop is larger than the largest value f* among values that were obtained in previous searches (calculations performed in the first to the (i−1)-th search loops) (“Yes” in step S10), the evaluation result determination unit 55 updates f* to be the value of the objective function f(yᵢ,C) obtained in the i-th search loop. Also, x* is updated to be the element x; with which the updated f* is obtained (step S11).

In a case where the objective function is a function that is to be minimized, f* is updated if f(yᵢ, C) is smaller than the smallest value f* among values that were obtained in previous searches (“Yes” in step S10). Also, x* is updated to be the element x; with which the updated f* is obtained (step S11).

The solution search loop is ended after being performed the same number n of times as the elements of X or when a search ending condition that is determined in advance is satisfied (“Yes” in step S12). On the other hand, if the search ending condition is not satisfied (“No” in step S12), the search loop is repeated from step 305.

The followings are specific examples of the search ending condition.

(1) The number of times of search (the upper limit of i)
(2) Search time
(3) A specific index or the value of the objective function is larger than or smaller than a predetermined value.
(4) It is clear that the value of x* obtained during the search will not be updated thereafter.

When the search is ended, the optimum access network notification unit 56 of the optimization engine 50 notifies the network selection units 11b of the terminals 11 and/or the terminal selection units 12a of the NWs 12 of connection destinations, based on x* (steps S13 and S14). Upon receiving the notification, the terminals 11 and the NWs 12 switch connection destinations in accordance with the notification. When the terminals 11 and the NWs 12 have switched the connection destinations, the terminals and the NWs are connected as indicated by x*.

### Embodiment 2

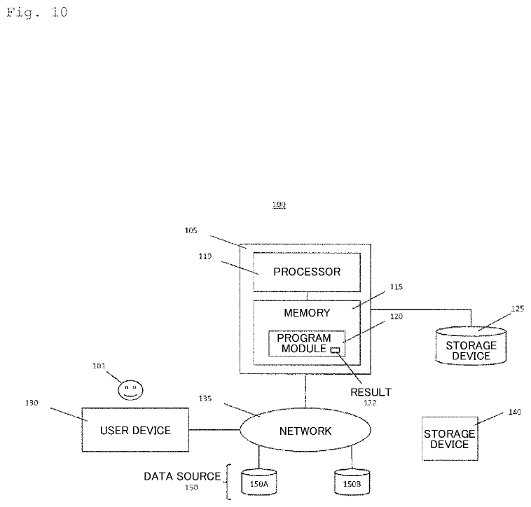

FIG. 9 is a diagram showing a communication system 302 that includes the optimization engine 50 according to the present embodiment. The communication system 302 includes an application server (application D) in a specific network (NW 12-4). The communication system 302 differs from the communication system 301 shown in FIG. 4 in that the application server is also present in the NW 12. In the present embodiment, differences of the communication system 302 from the communication system 301 will be described.

The optimization engine 50 of the communication system 302 selects access means that is to be used by a user, giving consideration to the fact that the application server with which the user terminal is to communicate is installed in the specific NW. In order to realize this, the optimization engine 50 needs to obtain information indicating that the application server with which the user terminal is to communicate is installed in the specific NW.

Therefore, the network feature values described above include correspondence information that indicates correspondence between an application and a specific access network that can realize the application among the access networks. In the case shown in FIG. 9, correspondence information indicating that the application D is connected to the NW 12-4 is necessary. The communication system 302 acquires the correspondence information as a vector Cₙ that is an array of feature values other than communication quality. The NW 12 may also have a list of applications that are realized in the NW 12, as the correspondence information.

The information collecting unit 51 collects application information of the application that the terminal uses, together with the above-described availability information, and

a utility function for reflecting the correspondence information and the application information in the above-described calculation value is set in the determination unit 55. The utility function will be described later.

As in the steps of searching for optimum connection destinations of respective terminals described using FIGS. 7 and 8, the optimization engine 50 estimates quality of a wireless access section or quality assuming Internet access, in estimating quality yᵢ with respect to a specific combination of connection destinations. On the other hand, when calculating the value of the objective function f(yᵢ(xᵢ),C), the optimization engine 50 defines a utility function of each terminal such that the value of the objective function increases or decreases if a specific NW is used according to an application. The utility function may also be a function that reduces or increases the value of the objective function if a terminal in a group of terminals is connected to a NW that does not enable the terminal to use an application.

For example, in the case shown in FIG. 9, servers of applications (A, B, and C) exist in the Internet 20, but the server of the application D is connected to the NW 12-4. The information collecting unit 51 of the optimization engine 50 obtains, as the network feature values C, information indicating that the connection destination of the application D is the NW 12-4 in advance. The objective function evaluation unit 54 of the optimization engine 50 calculates the value of the objective function f(yᵢ(xᵢ),C) as shown in FIGS. 7 and 8. The calculation can be performed as described in the first embodiment 1 with respect to connection destinations of terminals that use the applications (A, B, and C). On the other hand, with respect to the connection destination of a terminal that uses the application D, the objective function evaluation unit 54 performs the calculation such that the value of the objective function becomes larger than the calculation value described in the first embodiment when the terminal is connected to the NW 12-4 or the value of the objective function becomes smaller than the calculation value when the terminal is connected to a NW other than the NW 12-4.

As a result of the objective function evaluation unit 54 applying a utility function that corrects the calculation result of the objective function as described above, it is possible to increase the probability of the determination unit 55 selecting a connection destination candidate such that a terminal 11-3 that uses the application D is connected via the NW 12-4.

The present embodiment has the following merits.

It is possible to increase accuracy in selecting a NW that is suitable for an application or a service, to suppress a reduction in experience quality and improve experience quality. Also, the method for estimating communication quality described in the first embodiment can be used as is without being modified (by merely adding the utility function to the objective function).

### Specific Examples of Objective Function

A person who sets the objective function determines the objective function considering a business model, the degree of user satisfaction, equity, cost, or the like. By setting the objective function f(y,C), it is possible to allocate connection destinations to users in accordance with various objectives.

The following lists examples of the objective function. (1) A sum of estimated degrees of satisfaction (maximization)

$$[ Math . P 1 ]$$

$$f ( y , C ) = {\sum }_{m = 1}^{M} {h}_{m} \qquad ( P1 )$$

where h^{m} represents an estimated degree of satisfaction of a user m.
(2) The number of users whose estimated degrees of satisfaction are at least a set value (maximization)

[Math. P2]

f(y,C)=n(A)

A={m|hₘ≥hₒ} (P2)

where hₒ is a constant.
(3) A median value of estimated degrees of satisfaction (maximization)

[Math. P3]

f(y,C)=median(hₘ) (P3)

(4) Dispersion of estimated degrees of satisfaction (minimization)

$$[ Math . P 4 ]$$

$$f ( y , C ) = \frac{1}{M} {\sum }_{m = 1}^{M} {( {h}_{m} - \overline{h} )}^{2} \\ \overline{h} = \frac{1}{M} {\sum }_{m = 1}^{M} {h}_{m} \qquad ( P 4 )$$

(5) The degree of satisfaction of a user whose estimated degree of satisfaction is the lowest (maximization)

$$[ Math . P 5 ]$$

$$f ( y , C ) = {min}_{1 \leq m \leq M} {h}_{m} \qquad ( P 5 )$$

(6) Unevenness of load ratios of respective networks (minimization)

$$[ Math . P 6 ]$$

$$f ( y , C ) = \vert \frac{{l}_{a} - {l}_{b}}{{l}_{a} + {l}_{b}} \vert \qquad ( P6 )$$

where lₐ and l_{b} represent bandwidth usage ratios of access networks A and B, respectively.

In a case where there are three or more access networks, dispersion of bandwidth usage ratios lₙ of respective access networks can be used (in this expression, n represents an identification number of an access network).

$$[ Math . P 6 a ]$$

$$f ( y , C ) = \frac{1}{N} {\sum }_{n = 1}^{N} {( {l}_{n} - \overline{l} )}^{2} \\ \overline{l} = \frac{1}{N} {\sum }_{n = 1}^{N} {l}_{n} \qquad ( P 6 a )$$

(7) Difference from a desired network load ratio distribution (minimization)

$$[ Math . P 7 ]$$

$$f ( y , C ) = \vert \frac{γ {l}_{a} - {l}_{b}}{γ {l}_{a} + {l}_{b}} \vert \qquad ( P7 )$$

where y is b/a when it is desired to make lₐ:l_{b} equal to a:b. “a” and “b” represent positive values. In a case where connection destinations are allocated such that the ratio between the bandwidth usage ratios of the networks A and B is lₐ:l_{b}=3:4, for example, a=3 and b=4.

Note that in a case where there are a plurality of (N) access networks, the expression P7 can be generalized as the following objective function.

$$[ Math . P 7 a ]$$

$$f ( y , C ) = \frac{1}{N} {\sum }_{n = 1}^{N} {( {l}_{n} - {γ}_{n} {l}_{o} )}^{2} \qquad ( P 7 a )$$

where l_{Q} and lₙ respectively represent bandwidth usage ratios of a reference access network and the n-th access network (n is an integer no greater than N and excludes the reference access network). γₙ represents the value of a ratio between the bandwidth usage ratio of the reference network and the bandwidth usage ratio of the n-th network. That is, γₙ is the value of a case where the bandwidth usage ratio l_{Q} of the reference network and the bandwidth usage ratio lₙ of the n-th network are as follows: l_{Q}:lₙ==1:γₙ.
(8) A Sum of Line Usage Costs from the Standpoint of Mobile Virtual Network Operators (MVNOs) (Minimization)

$$[ Math . P 8 ]$$

$$f ( y , C ) = {\sum }_{n = 1}^{N} {p}_{n} {B}_{n} \qquad ( P8 )$$

where pₙ represents a line usage cost per band of an access network n, and Bₙ represents a data use amount per unit time of the access network n.

In cases where the objective functions of Expressions P1, P2, P3, and P5 are set, optimization is performed so as to maximize the objective functions in step S10 shown in FIG. 8. On the other hand, in cases where the objective functions of Expressions P4, P6, P7, and P8 are set, optimization is performed so as to minimize the objective functions in step S10 shown in FIG. 8.

The degree of user satisfaction used in Expressions P1 and P2 is an index for which consideration is given to both QoE (Quality of experience) that is determined by communication quality of each application, and influence α(C) of the array Cn of feature values other than communication quality of each access network. More specifically, the degree of user satisfaction is defined as follows.

[Math. P9]

hₘ=a(C)×QoE(y) (P9)

In a case where it is desired to improve a plurality of objective functions fᵢ(y,C), f₂(y,C), . . . , in a well-balanced manner, an objective function f(y,C) is set by compositing those objective functions. If degrees of importance of the respective objective functions fⱼ(y,C) differ from each other, each objective function fⱼ(y,C) may be weighted (j represents a natural number). The following describes methods for compositing objective functions. Here, a vector w is an array of weighting rates.

[Math. 5]

w={w¹,w₂, . . . , wj,|Σwₖ=1} (5)

(A) Method of expressing as a sum

[Math. 6]

f(y,C)=Σwⱼfⱼ(y,c) (6)

(B) Method of Expressing as a Product

$$[ Math . 7 ]$$

$$f ( y , C ) = \prod {{f}_{j} ( y , C )}^{{w}_{j}} \qquad ( 7 )$$

(C) Method of Replacing with Other Functions and Expressing as a Sum or a Product

When compositing the basic objective functions expressed by Expressions P1 to P8, there are cases where the objective functions cannot be taken into consideration in a well-balanced manner using the above-described method (A) or (B). For example, in order to consider an objective function that is to be maximized and an objective function that is to be minimized at the same time, it is necessary to composite the objective functions after converting either of the objective functions to the reciprocal, for example. Also, if there is a difference between a range of values that an objective function can take and a range of values that another objective function can take, contribution of the objective function that can take values in a larger range may become large. Therefore, in order to consider a plurality of objective functions equally, it may be necessary to perform standardization to adjust ranges of values that the respective objective functions can take. It is also possible to let g represent a function used for any of the above-described conversions and express an objective function f using a composite function of g and fⱼ.

For example, the objective function f can be set as follows.

[Math. 8]

f(y,C)=Σwⱼg(fⱼ(y,C))

f(y,C)=Πg(fⱼ(y,C))^{w}^{ⱼ} (8)

Here, a function that is to be minimized can be converted to a function that is to be maximized, using the following function.

$$[ Math . 9 ]$$

$$g ( {f}_{j} ( y , C ) ) = \frac{1}{{f}_{j} ( y , C ) )} \qquad ( 9 )$$

A function that is to be maximized can be converted to a function that is to be minimized, using the same function.

Also, a sigmoid function expressed by Expression 10 can be set as an example of the function g for converting the range of values that an objective function can take. In this case, g(fⱼ(y,C))∈[0,1] with respect to a given value of fⱼ(y,C).

$$[ Math . 10 ]$$

$$g ( {f}_{j} ( y , C ) ) = \frac{1}{1 + exp ( - a ( {f}_{j} ( y , C ) - {f}_{0} )} \qquad ( 10 )$$

where a and f₀ are constants.

Also, a function expressed by Expression 11 can be set as another example of the function g. In this case, g(fⱼ(y,C))∈[0, 1] under the condition of fⱼ(y,C)>0.

$$[ Math . 11 ]$$

$$g ( {f}_{j} ( y , C ) ) = 1 - exp ( - \frac{{f}_{j} ( y , C ) - {f}_{0}}{a} ) \qquad ( 11 )$$

where a and f₀ are constants.

In a case where conversion needs to be performed a plurality of times, a plurality of functions gₖ and gᵢ may be used at the same time. In this case, a function g that is finally used can be set as follows.

[Math. 12]

g(fⱼ(y,C))=(gₖ·gᵢ·fⱼ)(y,C) (12)

It is also possible to set a composite function of three or more functions.

### Specific Examples of Utility Function

1. A Case of an Application that can be Used Only in a Specific NW
(1) Method of Expressing the Utility Function with a Linear Expression

In a case where the m-th terminal (user) uses an application A that can be used only in the n-th NW, utility h_{mn′} of the user connected to the n′-th NW is defined as shown in the following expression using constants α_{n′} and β_{n′} that are defined for each NW. Here, QoE (y,C) represents a QoE value that is calculated using a suitable QoE model when the communication quality is represented by y and feature values are represented by C.

[Math. 21]

h_{m,n′}=α_{n′}QoE(y,C)+β_{n′} (21)

For example, if the utility h_{mn′} is calculated by setting α_{n′} and β_{n′} as follows:

$$[ Math . 21 a ]$$

$$\{ \begin{matrix}{α}_{{n}^{′}} = {β}_{{n}^{′}} = 0 & ( {n}^{′} \neq n ) \\ {α}_{{n}^{′}} = 1 , {β}_{{n}^{′}} = 0 & ( {n}^{′} = n )\end{matrix} \\ \{ \begin{matrix}{β}_{{n}^{′}} = - ∞ & ( {n}^{′} \neq n ) \\ {α}_{{n}^{′}} = 1 , {β}_{{n}^{′}} = 0 & ( {n}^{′} = n )\end{matrix} \qquad ( 21 a )$$

the utility h_{mn′} becomes large only when the terminal of the user m is connected to the network n. If the thus calculated utility h_{mn′} is used as the estimated degree of satisfaction of the user m in Expressions 1 to 5, the objective function f increases or decreases with respect to a connection combination in which the terminal of the user m is connected to the network n, and the terminal of the user m is preferentially connected to the network n.

### (2) Other Methods

A logical expression may be incorporated into the utility function. For example, the utility may be defined as follows using the Kronecker delta δ_{n′n}.

[Math. 22]

h_{mn′}=δ_{n′n}QoE(y,C) (22)

Also, the objective function may be set such that the value of the objective function becomes 0 if at least one terminal that uses the application A is connected to a NW in which the application A cannot be used.
2. A Case of an Application of which the Service Cannot be Used in a Specific NW
(1) Method of Expressing the Utility Function with a Linear Expression

In a case where a desired application cannot be used in the n-th NW, the following expression is applied to Expression 21.

$$[ Math . 21 b ]$$

$$\{ \begin{matrix}{α}_{{n}^{′}} = {β}_{{n}^{′}} = 0 & ( {n}^{′} \neq n ) \\ {α}_{{n}^{′}} = 1 , {β}_{{n}^{′}} = 0 & ( {n}^{′} = n )\end{matrix} \qquad ( 21 b )$$

### (2) Other Methods

In a case where the application A cannot be used when the network number n′ is equal to n, if Expression 22 is converted as follows:

[Math. 23]

h_{mn′}=(1−δ_{n′n})QoE(y,C) (23)

the utility h_{mn′} becomes high when the NW number n′ is not equal to n.

Also, the objective function may be set such that the value of the objective function becomes 0 if at least one terminal that uses the application A is connected to a NW in which the application A cannot be used.

3. A Case of an Application of which Utility Increases when the Application is Used Under a Specific NW

(1) Method of Expressing the Utility Function with a Linear Expression

In a case where the utility of an application increases in the n-th NW, with respect to the utility h, expressed by Expression 21, α_{n′} and β_{n′} are set so as to be large when n′ is equal to n. For example, if the influence on the utility varies depending on the magnitude of the QoE value, an, is increased (in Expression 21a, α_{n′}=1=, but in this example, α_{n′} >1), and if the utility increases independently of the magnitude of the QoE value, β_{n′} is increased (in Expression 21a, β_{n′}=0, but in this example, β_{n′}>0).

(2) Method of Expressing the Utility Function with a Nonlinear Expression

As a method for simulating influence of the QoE value on the utility, there is a method of defining a nonlinear function that takes QoE as a variable, as the utility.

For example, if the utility is defined as follows:

[Math. 24]

h_{mn′}=1−exp(−α_{n′}QoE(y,C))

xα_{n′}>0 (24)

movement to a NW in which the utility is likely to increase frequently occurs between NWs in which QoE is low, but movement is unlikely to occur between NWs that have high NW quality and sufficiently high QoE. In the case where the utility increases in the network n, α_{n′} is made large (e.g., α_{n′}>1).
4. A Case of an Application of which Utility Decreases when the Application is Used Under a Specific NW
(1) Method of Expressing the Utility Function with a Linear Expression

In a case where the utility of an application increases in the n-th NW, with respect to the utility h_{nm′} expressed by Expression 21, α_{n′} and β_{n′} are set so as to be small when n′ is equal to n. For example, if the influence on the utility varies depending on the magnitude of the QoE value, α_{n′} is reduced (in Expression 21a, α_{n′}=1, but in this example, 0<α_{n′}<l), and if the utility decreases independently of the magnitude of the QoE value, β_{n′} is reduced (in Expression 21a, β_{n′}=0, but in this example, β_{n′}<0).

(2) Method of expressing the utility function with a nonlinear expression

A method similar to that described above in 3(2) is used. In the case where the utility decreases in the network n, α_{n′} is made small (e.g., 0<α_{n′}<1) in Expression 23.

5. A Case of an Application of which the Service can be Used in a Plurality of NWs and the Service Cannot be Used in a Plurality of NWs
(1) Method of Expressing the Utility Function with a Linear Expression

A set n of NWs in which the application A can be used is defined, and Expression 21 is used with the parameters set as shown in the following expression.

$$[ Math . 21 c ]$$

$$\{ \begin{matrix}{α}_{{n}^{′}} = {β}_{{n}^{′}} = 0 & ( {n}^{′} ∉ n ) \\ {α}_{{n}^{′}} = 1 , {β}_{{n}^{′}} = 0 & ( {n}^{′} ∈ n )\end{matrix} \\ \{ \begin{matrix}{β}_{{n}^{′}} = - ∞ & ( {n}^{′} ∉ n ) \\ {α}_{{n}^{′}} = 1 , {β}_{{n}^{′}} = 0 & ( {n}^{′} ∈ n )\end{matrix} \qquad ( 21 c )$$

### (2) Other Methods

Similarly to the method described above in 1(2), the objective function may be set such that the value of the objective function becomes 0 if at least one terminal that uses the application A is connected to a NW in which the application A cannot be used.

6. A Case of an Application of which Utility Increases in a Plurality of NWs and the Utility Decreases in a Plurality of NWs
(1) Method of Expressing the Utility Function with a Linear Expression

A set of NWs in which the utility of the application A increases is defined as u, a set of NWs in which the utility decreases is defined as d, and with respect to the utility h_{mn′} expressed by Expression 21, α_{n′} and β_{n′} are increased when n′∈eset u (in Expression 21a, α_{n′}=1 and β_{n′}=0, but in this example, 0<α_{n′}<1 and α_{n′}<0). On the other hand, α_{n′} and is are reduced when n′∈set d (in Expression 21a, α_{n′}=1 and β_{n′}=0, but in this example, 0<α_{n′}<1 and β_{n′}<0).

(2) Method of Expressing the Utility Function with a Nonlinear Expression

The set of NWs in which the utility of the application A increases is defined as u, the set of NWs in which the utility decreases is defined as d, and with respect to the utility h_{mn′} expressed by Expression 24, α_{n′} is made large when n′∈set u (in Expression 21a, α_{n′}=1, but in this example, α_{n′}>1). On the other hand, an, is made small when n′∈set d (in Expression 21a, α_{n′}=1, but in this example, 0<α_{n′}<1).

7. A Case of an Application of which Utility Varies Depending on NWs
(1) Method of Expressing the Utility Function with a Linear Expression

With respect to the utility h_{mn′} expressed by Expression 21, α_{n′} and β_{n′} are set to suitable values among all real numbers, for each NW.

(2) Method of Expressing the Utility Function with a Nonlinear Expression

With respect to the utility h_{mn′} expressed by Expression 24, α_{n′} is set to a suitable value among all real numbers, for each NW.

Example of Optimization Engine

The optimization engine 50 described above can be realized by a computer and a program, and the program can be recorded on a recording medium or provided via a network.

FIG. 10 shows a block diagram of a system 100. The system 100 includes a computer 105 that is connected to a network 135. Note that the system 100 corresponds to the communication system 301 and the computer 105 corresponds to the optimization engine 50.

The network 135 is a data communication network. The network 135 may be a private network or a public network and can encompass all or any of: (a) a personal area network that covers a room, for example; (b) a local area network that covers a building, for example; (c) a campus area network that covers a campus, for example; (d) a metropolitan area network that covers a city, for example; (e) a wide area network that covers a region that spans across a boundary between cities, districts, or countries, for example; and (f) the Internet. Communication is performed via the network 135 using electronic signals and optical signals. Note that the network 135 corresponds to the NW 12 and the upper network 13.

The computer 105 includes a processor 110 and a memory 115 that is connected to the processor 110. In the present specification, the computer 105 is described as a stand-alone device, but there is no limitation thereto, and the computer may be connected to another device (not shown) in a distributed processing system.

The processor 110 is an electronic device that is constituted by a logic circuit that responds to commands and executes commands.

The memory 115 is a storage medium on which a computer program is encoded and can be read by a tangible computer. With regard to this, data and commands, i.e., program codes that can be read and executed by the processor 110 are stored on the memory 115 to control operations of the processor 110. The memory 115 can be realized by a random access memory (RAM), a hard drive, a read-only memory (ROM), or a combination of any of these. A program module 120 is a constitutional element of the memory 115.

The program module 120 includes commands for controlling the processor 110 so as to execute the processes described in the present specification. In the present specification, operations are described as being executed by the computer 105, a method, a process, or a subordinate process, but those operations are actually executed by the processor 110.

In the present specification, the term “module” refers to functional operations that can be realized as a stand-alone constitutional element or an integrated configuration constituted by a plurality of subordinate constitutional elements. Accordingly, the program module 120 can be realized as a single module or a plurality of modules that cooperate with each other. Furthermore, in the present specification, the program module 120 is described as being installed in the memory 115, and accordingly, realized by software, but the program module can be realized by hardware (e.g., an electronic circuit), firmware, software, or a combination of any of these.

The program module 120 is shown as having been already loaded to the memory 115, but may be present on a storage device 140 so as to be loaded to the memory 115 later. The storage device 140 is a storage medium on which the program module 120 can be stored and can be read by a tangible computer. Examples of the storage device 140 include a compact disk, a magnetic tape, a read-only memory, an optical storage medium, a memory unit constituted by a hard drive or a plurality of parallel hard drives, and a universal serial bus (USB) flash drive. Alternatively, the storage device 140 may be a random access memory or an electronic storage device of another type that is present in a remote storage system (not shown) and is connected to the computer 105 via the network 135.

The system 100 further includes data sources 150A and 150B that are collectively referred to as data sources 150 in the present specification and are communicably connected to the network 135. Actually, the data sources 150 can include a suitable number of data sources, i.e., one or more data sources. The data sources 150 include unsystematized data and can include social media.

The system 100 further includes a user device 130 that is operated by a user 101 and is connected to the computer 105 via the network 135. Examples of the user device 130 include an input device such as a keyboard or an audio recognition subsystem that enables the user 101 to notify the processor 110 of information and selection of a command. The user device 130 further includes an output device such as a display device, a printer, or a speech synthesis device. A cursor control unit such as a mouse, a trackball, or a touch sensitive screen enables the user 101 to operate a cursor on a display device to notify the processor 110 of further information and selection of a command. Note that the user device 130 corresponds to the terminal 11.

The processor 110 outputs a result 122 of execution of the program module 120 to the user device 130. Alternatively, the processor 110 can give the output to a storage device 125 such as a database or a memory, for example, or to a remote device (not shown) via the network 135.

For example, the program module 120 may be a program for performing the operations shown in FIG. 7. The system 100 can be caused to operate as the optimization engine 50.

The term “include” or “including” specifies the presence of a feature, a complete body, a step, or a constitutional element that is mentioned, but should be interpreted as not excluding the presence of one or more other features, complete bodies, steps, constitutional elements, or a group of these. The words “a” and “an” are indefinite articles, and therefore do not exclude embodiments that include a plurality of elements described after these words.

### OTHER EMBODIMENTS

Note that the present invention is not limited to the above embodiments, and can be implemented with various changes made within a range not departing from the gist of the present invention. That is, the present invention is not limited to the above embodiments as is, and can be implemented with the constitutional elements modified within a range not departing from the gist of the present invention.

Also, various inventions can be made by appropriately combining a plurality of constitutional elements disclosed in the above embodiments. For example, some constitutional elements may be omitted from all constitutional elements described in the embodiments. Furthermore, constitutional elements of different embodiments may be combined as appropriate.

### REFERENCE SIGNS LIST

11 Terminal
11a Terminal information notification unit
11b Network selection unit
12 Access network (NW)
12a Terminal selection unit
12b Network information notification unit
13 Upper network
Internet
50 Optimization engine
51 Information collecting unit
52 Search candidate selection unit
53 Quality estimation unit
54 Objective function evaluation unit
55 Evaluation result determination unit
56 Optimum network notification unit
100 System
101 User
105 Computer
110 Processor
115 Memory
120 Program module
122 Result
125 Storage device
130 User device
135 Network
140 Storage device
150 Data source
301, 302 Communication system

1. An optimization engine for optimizing a communication system, wherein
the communication system has a configuration in which a plurality of terminals are each connected to an upper network via any of a plurality of access networks,
the optimization engine comprising:
a processor; and
a storage medium having computer program instructions stored thereon, when executed by the processor, perform to:
collect communication quality information and network feature values for each of the access networks and availability information for each of the terminals, the availability information indicating which of the access networks can be used by the terminal;
create connection destination candidates for each of the terminals based on the availability information, the connection destination candidates being candidates for an access network among the access networks to which the terminal is to be connected;
estimate communication quality with respect to the connection destination candidates based on the communication quality information, to obtain estimated communication quality; and
determine an optimum connection destination from among the connection destination candidates based on a calculation value that is obtained by substituting the network feature values and the estimated communication quality into an objective function that is set in advance.

2. The optimization engine according to claim 1, wherein
the network feature values include correspondence information that indicates correspondence between an application and a specific access network among the access networks in which the application can be realized,
wherein the computer program instructions further perform to collects application information of the application that the terminal uses, together with the availability information, and
a utility function for reflecting the correspondence information and the application information in the calculation value is set.

3. The optimization engine according to claim 1, wherein the computer program instructions further perform to determines a connection destination candidate that maximizes or minimizes the objective function as the optimum connection destination.

4. The optimization engine according to claim 1, wherein the computer program instructions further perform to output connection instructions to the terminals and/or the access networks such that each of the terminals is connected to an access network that is the optimum connection destination.

5. An optimization method for optimizing a communication system, wherein
the communication system has a configuration in which a plurality of terminals are each connected to an upper network via any of a plurality of access networks,
the optimization method comprising:
collecting communication quality information and network feature values for each of the access networks and availability information for each of the terminals, the availability information indicating which of the access networks can be used by the terminal;
creating connection destination candidates for each of the terminals based on the availability information, the connection destination candidates being candidates for an access network among the access networks to which the terminal is to be connected;
estimating communication quality with respect to the connection destination candidates based on the communication quality information, to obtain estimated communication quality; and
determining an optimum connection destination from among the connection destination candidates based on a calculation value that is obtained by substituting the network feature values and the estimated communication quality into an objective function that is set in advance.

6. The optimization method according to claim 5, wherein
the network feature values include correspondence information that indicates correspondence between an application and a specific access network among the access networks in which the application can be realized, and
the optimization method further comprising:
collecting application information of the application that the terminal uses, together with the availability information; and
reflecting the correspondence information and the application information in the calculation value by using a utility function.

7. The optimization method according to claim 5, wherein
a connection destination candidate that maximizes or minimizes the objective function is determined as the optimum connection destination.

8. The optimization method according to claim 5, further comprising
outputting connection instructions to the terminals and/or the access networks such that each of the terminals is connected to an access network that is the optimum connection destination.

9. A non-transitory computer-readable medium having computer-executable instructions that, upon execution of the instructions by a processor of a computer, causing a computer to function as the optimization engine according to claim 1.
